(19) United States
(12) Patent Application Publication
(10) Pub. No.: US 2009/0030889 A1
(43) Pub. Date: Jan. 29, 2009

(54) VIEWING OF FEEDS

(76) Inventors: Ehud Chatow, Palo Alto, CA (US); Andrew E. Fitzhugh, Menlo Park, CA (US); Andrew Bolwell, Santa Cruz, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/828,343

(22) Filed: Jul. 25, 2007

(51) Int. Cl. G06F 17/30

(52) U.S. Cl. 707/5; 707/E17.107

(57) ABSTRACT

Feed selections are automatically arranged into a single publication, and the publication is sent to print.

### BACKGROUND

Really Simple Syndication (“RSS”) is a family of web feed formats used to publish frequently updated content such as blog entries, news headlines and podcasts. RSS enables people to keep up with their favorite web sites in an automated manner rather than manually checking and pulling content from the web sites.

The feeds are viewed according to an on-line paradigm. Programs such as web browsers are used to access the feeds, and the feeds are displayed and viewed on a screen.

### BRIEF DESCRIPTION OF THE DRAWINGS

FIG. 1 is an illustration of a method of viewing feeds in accordance with an embodiment of the present invention.

FIG. 2 is an illustration of a method of accessing feed selections in accordance with an embodiment of the present invention.

FIG. 3 is an illustration of a method of creating a publication from feed selections in accordance with an embodiment of the present invention.

FIG. 4 is an illustration of a method of enhancing a publication in accordance with an embodiment of the present invention.

FIG. 5 is an illustration of a machine in accordance with an embodiment of the present invention.

### DETAILED DESCRIPTION

As shown in the drawings for purposes of illustration, feeds are viewed according to a print paradigm. As used herein, a feed refers to digital content having a format that provides frequently updated content to users. A feed is not limited to any particular type. The feed could be a web feed such as an RSS feed or a picture feed. However, a feed is not limited to an Internet or Intranet feed. A feed could be generated by a telecom provider over its own network for its mobile phone users. A feed is not even limited to a network. A feed could exist locally on a computer and not require a network of any type for transmission.

The content contained within a feed is typically defined by its publisher. A magazine or newspaper publisher, for instance, will typically define multiple feeds, some corresponding to different sections (e.g., national news, business, sports), to particular columnists, etc.

Some embodiments of the present invention may be performed by a central service provider. Consider a web-based service provider such as Google or Yahoo. Each company offers various services for providing web feeds. For instance, Google offers Google Reader, which checks favorite web sites, news sites and blogs for new content. Yahoo offers My Yahoo!, which provides personalized web content such as TV listings, bookmarks to other web sites, links to selected newspaper articles, links to stock market information, etc. A user (e.g., a person subscribing to a service) can access these services via the service providers' web sites.

The feeds can be read using an application called a “feed reader” or an “aggregator.” A user may subscribe to a feed by entering the feed's link into the aggregator or by clicking an RSS icon that initiates the subscription process. The aggregator checks the user's subscribed feeds regularly for new content, downloading any updates that it finds.

The aggregator is not limited to any particular platform. For example, the aggregator can be run on a personal computer or a mobile device.

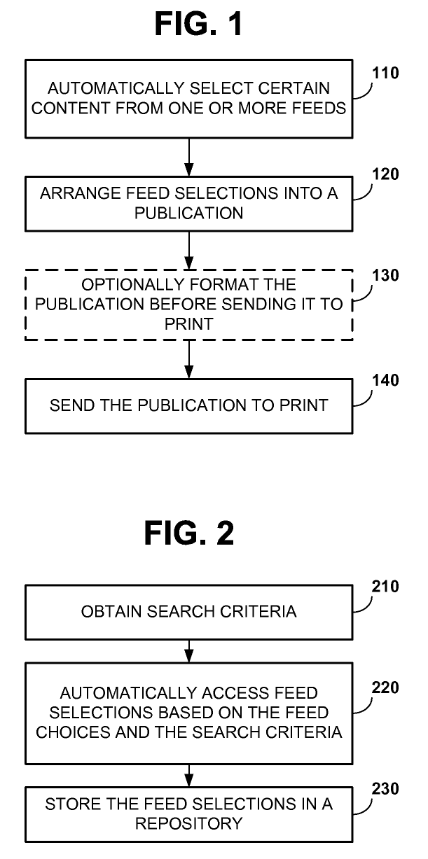

Reference is made to FIG. 1, which illustrates a method of viewing feeds. At block 1 10, certain content is automatically selected from one or more feeds. The content may be selected according to some search criteria. The selected content is referred to as “feed selections.”

For example, a user had previously selected three feeds that are published by sports magazines and two more feeds for the sports section of two newspapers. The user had also previously indicated an interest in a particular sports team. A service provider, for instance, searches these five feeds and returns images and articles (feed selections) about that sports team.

At block 120, the feed selections are arranged into a publication. The feed selections can be converted to a standard document format (e.g., pdf or XML) and concatenated or otherwise arranged. This step may also be performed automatically. For example, a service provider can arrange the feed selections or have someone else do it.

At block 130, the publication may be formatted before being sent to print. The formatting is not limited to any particular type. The feed selections may be placed in a format that is consistent with a certain type of publication. Examples of different types of publication formats include, but are not limited to, those of personal magazines, personal catalogues, books, newsletters, and combinations thereof.

The resulting publication is not limited to a concatenation of feed selections. Rather, it can be an arrangement of feed selections that has the look and feel of a certain type of publication.

As a first example, the publication contains only those articles that are of interest to a person, and it has the look and feel of a newspaper. As a second example, the publication contains articles and blog content that are of interest to a person, and it has the look and feel of a magazine. As a third example, a publication contains both news articles and documents. The news articles are formatted to have the look and feel of a magazine, and the documents are formatted to have the look and feel of professional reports.

At block 140, the publication is sent to print. The publication can be sent back to the user for printing on a local printer. In the alternative, the publication can be sent to another party for printing, such as a print service provider (PSP). The PSP could print the publication and deliver it to a specified location. Although the publication is sent to print, it might not be printed immediately. For instance, the publication might be sent to a short term server storage prior to printing.

The method of FIG. 1 shifts the viewing of feeds from an on-line paradigm to a print paradigm. The print paradigm offers advantages over the on-line paradigm For instance, multiple pages are usually easier and faster to read and digest in a printed format.

The print paradigm is not tethered to an Internet connection. Via a print paradigm, a person can read the feed selections at locations that do not offer Internet access.

Higher visual quality can be achieved for images in print than on a screen. A print can be made with higher resolution and sharpness. A print also looks better under external sunlight or other intense light exposures.

Reference is now made to FIG. 2, which illustrates an example of how the feed selections are accessed. This example involves a service provider.

At block 210, the service provider receives feed choices from a user. These choices may be made with an aggregator. For example, a user clicks RSS icons in an aggregator, and the aggregator sends the corresponding feed links choice to the service provider.

Also at block 210, the service provider obtains search criteria. The search criteria includes, but is not limited to, image quality, file size, feed date (e.g., most recent news receives highest priority), content of interest (as indicated by, for example, tags and keywords).

Consider the example above about the five feeds. These feeds may be specified at block 210. The preference for the particular sports team may be supplied as part of the search criteria (also at block 210). In addition, the search criteria indicate a preference for high image quality, time of picture capture, place, source of information, author, editor, etc.

The user may supply the search criteria to the service provider. The user may select different criteria from a menu offered by a browser, and the browser sends the selected criteria to the service provider. The search criteria may also be entered and supplied to the service provider via an aggregator.

The search criteria may be determined or refined automatically. With time and usage, the service provider can learn about the user, develop a profile, and identify user interests. This information can be used to automatically select feeds and generate search criteria for the user.

Feeds may be selected and search criteria may be determined automatically from recipient interests. Recipient interests might include geographic location, reading interests, hobbies, affiliations, memberships, desired level of advertising, etc. Obtaining information about recipient interests is described in assignee's U.S. Ser. No. 11/694,914 filed 30 Mar. 2007, which is incorporated by reference.

At block 220, the service provider automatically accesses feed selections based on the feed choices and the search criteria. A search engine could be used to select content from feeds. The feed selections could include images, text, graphics and blogs.

At block 230, the service provider stores the feed selections in a repository (e.g., in server-accessible memory). Certain stored selections may be overwritten or replaced. For instance, if the user criteria specifies high quality images, saved images will be overwritten by similar images having higher quality.

The feeds may be searched periodically. Although the actual frequency will be application-specific, the selected feeds might be searched several times a day.

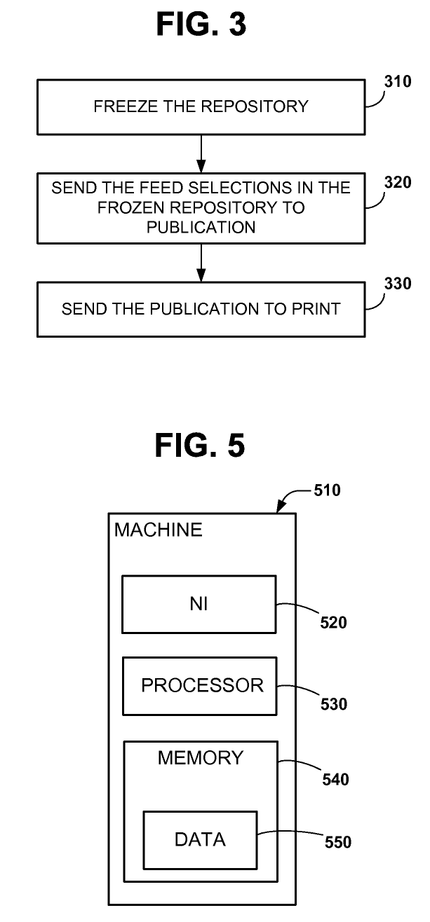

Reference is now made to FIG. 3, which illustrates an example of creating a publication from feed selections. At block 310, the repository is “frozen” (that is, no more feed selections are added). The repository may be frozen upon request by a user. For instance, if a user has to catch a flight the next day, that user might want the repository frozen immediately so a publication can be created and delivered to the airline (which can then deliver the publication to the user at the gate or on the plane).

Alternatively, the repository may be frozen according to a user-defined custom schedule. For instance, publication creation can be scheduled periodically (e. g., weekly, monthly), or according to an ad-hoc special print schedule, or whenever the repository has been filled with a predefined number of pages (e.g., once a page limit for the publication has been reached).

The user-defined schedule could be offered as part of a subscription service. For instance, the user pays a certain amount of money for X number of pages. The cost of the service could be subsidized in part or in full by allowing a certain amount of advertising in the publication.

At block 320, the feed selections in the frozen repository are sent to publication. The feed selections are arranged into a publication, and the publication is formatted. The publication may also be enhanced. Examples of enhancing a publication will be described below.

The formatting may be performed, before, during or after the enhancements are applied. Formatting includes giving the publication a certain look and feel. The publication may be formatted with predefined templates and page masters that are pre-defined. Some templates and page masters could be user-supplied.

Formatting could also include fitting the feed selections and any other material (e.g., advertisements, personalized content, and filler content) to the length of a page. In general, the formatting can include improving the appearance, organization and readability of a publication.

A repository may be partitioned, where each partition contains a different type of content (e.g., pictures, news articles, sports). The content in the different partitions can be formatted differently. For example, a first print template could be applied to news content, a second print template could be applied to sports, and so on. The formatted content is then combined into a single publication. Instead of partitioning a single repository, different repositories may be used.

The publication could be sent (e.g., e-mailed) to a user, who uses a word processing program, publishing program, publication wizard or some other program to perform the formatting. A publishing program might have the following features: standard toolbars for image editing and word processing operations; an interface for adding additional content; and a menu of templates and page masters that can be applied to the publication. The program can also provide an interface for sending the formatted publication back to the service provider or to a print service provider, or to a local printer.

The publication could be formatted on-line. For example, a user logs into web site, accesses the publication, and uses web-based tools to format and enhance the publication.

The publication could be formatted automatically, in addition to or instead of manual intervention. For example, formatting preferences could be indicated at block 210 of FIG. 2, and the publication can be automatically formatted according to those preferences.

At block 330, the publication is sent to print. A service provider can print the publication and send it (e.g., by mail, fax) to the user. Or, the service provider can send the publication in electronic form to a print service provider, which prints out the publication and sends the publication to the user or other recipient. As a first example, a service provider e-mails a printed publication to a print shop, where a user later picks it up. As a second example, the service provider e-mails a publication to a hotel at which a user is (or will be) staying. The hotel then prints the publication and gives it to the user. As a third example, a service provider e-mails a publication to a user, who prints it on a local printer.

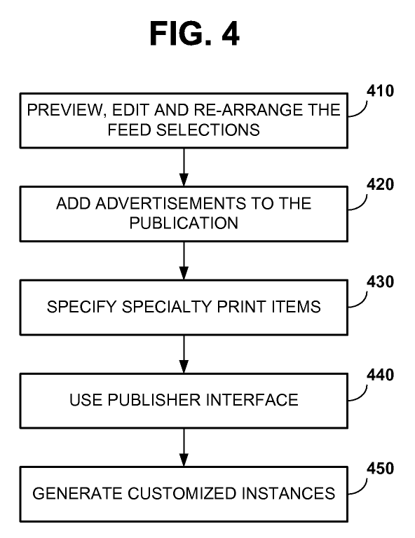

Reference is now made to FIG. 4, which illustrates various ways in which a publication can be enhanced prior to being sent to print. All of the ways illustrated in FIG. 4 are optional and can be performed in any order.

At block 410, the feed selections are previewed, edited and re-arranged. This re-arrangement can be performed by the user. This can be performed with a word processing program, image editing program, publishing program, etc.

At block 420, one or more advertisements can be added to the publication. The advertisements can be added to partially or fully subsidize the cost of preparing the publication. A service provider may identify advertisements that can be placed in a publication.

At block 430, specialty print items can be specified. As examples, a certain print media type or color properties (e.g., CMYK, CMYKcm, hexachrome or larger gamut) might be specified. Other specialty services, such as applying bindings, special finishes, etc., might be specified. A PSP capable of fulfilling the specified print options (and other criteria, such as cost) would then be selected.

At block 440, the publication can be enhanced by using a Publisher Interface. As used herein, a Publisher Interface refers to an embodiment of a platform disclosed in assignee's U.S. Ser. No. 11/741,718 filed 27 Apr. 2007, which is incorporated herein by reference. The Publisher Interface provides access to a wide variety of resources (e.g., content providers, designers, advertisers, editors, print service providers) of varying degrees of quality. A person with little or no knowledge of desktop publishing can enlist selected parties to create a professional-looking publication. A publisher doesn't need to understand the intricacies of document publishing. A publisher doesn't need to establish a network of content providers, designers, advertisers. The Publishing Interface could incorporate a method according to an embodiment of the present invention (e.g., automatically arranges feed selections into a single publication, and sends the publication to print).

At block 450, the feed selections are used as common content, and customized instances may be generated from the common content. Thus, the feed selections may be included in each instance. However, the different instances may also include additional content that is different. Examples of the additional content include, but are not limited to, jokes, quotes, and reviews. The different instances may also include different advertisements, and different designs (applying a theme, higher quality templates, art work), and any other customized material.

The instances may be customized according to recipient interests. An instance may contain customized content (e.g., stories of interest, regional information, certain editorials, photos from specific places of interest to a recipient). An instance may contain a customized design (e.g., an appropriate template or style sheet, a theme for special occasion, a layout with cartographic styles for a recipient interested in travel, use of a predominant color for a holiday, certain image borders or frames, fonts, page numbers and other graphical elements). Customizing instances of a publication is described in assignee's U.S. Ser. No. 11/694,914 filed 30 Mar. 2007. The Publisher Interface could be used to perform the customization.

Advertisements in an instance may also be customized according to a recipient's interests. Customization of advertisements is also described in assignee's U.S. Ser. No. 11/460,488 filed Jul. 27, 2006, which is incorporated by reference.

Customization of advertising has particular advantages. For example, a recipient might be willing to pay full cost for an instance, provided that the instance does not contain advertising. Or a recipient might accept a certain amount of advertising in an instance so that the instance is subsidized in part by advertisements. As a result, the recipient's cost of the instance would be reduced.

Reference is made to FIG. 5, which illustrates a general hardware implementation of a method according to an embodiment of the present invention. The hardware implementation includes a machine 510 having a network interface 520, a processor 530, and memory 540. The memory 540 includes data 550 (e.g., code) for causing the processor 530 to perform a method according to an embodiment of the present invention. If the method is performed by an online service provider, the machine could be a server. An online service provider might use multiple servers to provide an online service to its many subscribers.

1. A method comprising:
automatically arranging feed selections into a single publication; and
sending the publication to print.

2. The method of claim 1, further comprising obtaining the feed selections automatically according to search criteria.

3. The method of claim 2 wherein the search criteria is determined automatically.

4. The method of claim 3, wherein the search criteria is determined automatically from recipient interests.

5. The method of claim 1, wherein a service provider provides a service for automatically arranging the selected feeds into the single publication.

6. The method of claim 1, wherein the feed selections are accessed from feeds and stored in a repository.

7. The method of claim 6, wherein the repository is filled until it is frozen.

8. The method of claim 6, wherein the repository is frozen according to a schedule.

9. The method of claim 1, further comprising formatting the publication before the publication is sent to print.

10. The method of claim 9, wherein manual intervention is allowed to perform the formatting.

11. The method of claim 1, further comprising enhancing the publication before sending it print.

12. The method of claim 11, wherein the enhancing includes re-arranging the feed selections in a different order

13. The method of claim 11, wherein the enhancing includes using a Publisher Interface.

14. The method of claim 11, wherein the enhancing includes adding additional content to the publication.

15. The method of claim 11, wherein the enhancing includes adding advertisements to the publication.

16. The method of claim 11, wherein the enhancing includes using the arranged feed selections as common content; and generating customized instances from the common content.

17. Apparatus comprising a processor for causing a machine to perform the method of claim 1.

18. An article comprising memory encoded with data for causing a machine to perform the method of claim 1.

19. A machine comprising:
means for automatically arranging selected feeds into a single publication;
means for formatting the publication; and
means for sending the publication to print.

20. A system comprising apparatus for automatically arranging selected feeds into a single publication, and sending the publication to print.

21. An article comprising memory encoded with data that causes a processor to automatically arrange selected feeds into a single publication, and send the publication to print.
